(19) United States
(12) Patent Application Publication
(10) Pub. No.: US 2014/0314944 A1
(43) Pub. Date: Oct. 23, 2014

(54) INDUSTRIAL METHOD FOR PREPARING ALKALINE HYDROLYSATES OF VEGETABLE PROTEINS

(71) Applicants: Sophie Duvet, Quesnoy sur Deule (FR); Claire Dhalleine, Compiegne (FR)

(72) Inventors: Sophie Duvet, Quesnoy sur Deule (FR); Claire Dhalleine, Compiegne (FR)

(73) Assignee: ROQUETTE FRERES, Lestrem (FR)

(21) Appl. No.: 14/117,232

(22) PCT Filed: May 16, 2012
(86) PCT No.: PCT/FR2012/051107

§ 371 Date: Nov. 12, 2013

(30) Foreign Application Priority Data
May 16, 2011 (FR) 11 54241

(51) Int. Cl. A23J 3/32; A23L 1/305

(52) U.S. Cl. CPC A23J 3/32; A23L 1/3055
USPC 426/656

(57) ABSTRACT

A method for preparing alkaline hydrolysates of vegetable proteins, includes the following steps: 1) placing the vegetable proteins in suspension in water so as to have a concentration of 15 to 30 dry weight %, at a temperature of 70 to 80° C. and a pH of 9.5 to 10.5 by adding an alkaline hydroxide selected from the group made up of sodium hydroxide and potassium hydroxide; 2) allowing the suspension to incubate for 10 to 15 hours, at a temperature of 70 to 80° C. and a pH of 9.5 to 10.5; 3) neutralizing the heated suspension with a mineral acid; and 4) drying the neutralized suspension so as to obtain the alkaline hydrolysate.

The present invention relates to an industrial method for preparing alkaline hydrolysates of plant proteins.

Plant or animal proteins and hydrolysates of plant or animal proteins are often used as foaming agents in food products, notably in confectionery:

proteins as such, chosen as foaming agents that are stable over time,

protein hydrolysates, for their higher foaming capacity than for proteins.

Numerous documents describe the foaming properties of protein hydrolysates. The most recent documents discuss the enzymatic hydrolysis of proteins, whereas earlier works describe the alkaline hydrolysis of proteins.

The methods described illustrate the great variability of the operating conditions used; for example, short hydrolysis times or, on the contrary, very long hydrolysis times.

Patent GB 705489 thus relates to the hydrolysis of peanut proteins using sodium hydroxide.

The treatment is carried out in water at 82° C. for 30 minutes, followed by neutralization with hydrochloric acid. “Whipping” hydrolysates are then obtained.

Patent U.S. Pat. No. 2,999,753 describes, for its part, alkaline hydrolysates of plant proteins obtained after treatment at pH 10.7-10.8 and at a temperature of between 37 and 80° C., for 8 to 20 hours.

Patent U.S. Pat. No. 2,522,050 even describes a method for manufacturing foaming agents by alkaline hydrolysis of a soybean protein or milk protein in an aqueous solution containing calcium hydroxide or magnesium hydroxide at a pH of at least 10 and at a temperature said to be well below 100° C. (35-40° C.) for at least two days in order to obtain a product having satisfactory foaming properties.

Thus, it should be noted that this document recommends:

selecting reaction temperatures less than or equal to 40° C.,

giving preference to hydroxides of calcium or of magnesium, and especially hydroxides of calcium in order to obtain hydrolysates of proteins displaying the best foaming properties,

giving preference to long reaction times.

Thus, patent GB 670,413 describes a method for preparing foaming agents by hydrolysis of proteins at room temperature for a period of at least 24 hours, hydrolysis being performed using a calcium hydroxide.

It is also mentioned in this patent that, although it is possible to hydrolyze proteins at a higher temperature, of the order of 100° C. and higher, this will be to the detriment of the desired foaming properties.

However, although hydrolysis with calcium hydroxide is often recommended, the hydrolysates produced have a very bad taste, which is a serious handicap. Generally they are in fact chalky and bitter, and moreover have a sulfury and rubbery taste.

Raising the temperature during hydrolysis with calcium hydroxide can reduce the reaction time, but increases the formation of these undesirable flavors.

To take account of all these requirements, patent EP 1,327,390 therefore proposes a method for aerating a food product containing carbohydrates using a hydrolysate of plant protein as foaming agent, said hydrolysate being obtained by subjecting the plant protein to hydrolysis in an aqueous solution with a pH of at least 10.

This alkaline hydrolysate then has an average length of peptide chain from 5 to 20 amino acids and an amount of free amino acids less than 15 wt % of the total matter derived from proteins.

However, to achieve this result, the original method of alkaline hydrolysis described in patent EP 1,327,390 requires combining alkali metal hydroxides and alkaline-earth hydroxides, i.e. combining at least one alkali metal hydroxide such as NaOH or KOH with at least one alkaline-earth hydroxide, for example Ca(OH)₂ or Mg(OH)₂.

Efficient alkaline hydrolysis, according to the terms of said patent EP 1,327,390, therefore can only be obtained by a quite particular manner of carrying out hydrolysis.

International patent application WO 95/25437 describes a method for producing hydrolysates of plant proteins with an improved coloration by extracting the proteins contained in vegetable flours at a pH above the isoelectric pH of the protein, optionally in the presence of adsorbents, and hydrolysis of the protein thus obtained in the presence of adsorbents with alkalis, acids and/or enzymes in a manner described as “known per se”.

The protein hydrolysates thus obtained can then be used notably as surfactants.

The method recommended for alkaline hydrolysis in fact consists in treating the aqueous alkaline suspension of the protein isolates once again with calcium oxides or hydroxides.

The solution obtained must then be filtered to remove the residues.

To obtain the peptides as such, the peptides must be treated further in the form of calcium salts with sodium hydroxide or potassium hydroxide, and the residual calcium must then be removed, for example in the form of calcium sulfate.

Separation of the salts with low solubility must finally be carried out in the presence of filter aids on filters and filter-presses.

The hydrolysates thus obtained, after concentration, have an average molecular weight varying from 100 to 30 000 dalton, preferably 100 to 10 000 dalton and especially from 2000 to 5000 dalton and a dry matter content from 5 to 50 wt %.

Patent EP 1,909,592 describes a method for producing protein hydrolysates enriched in manganese, intended in animal husbandry as controlled sources of supply of manganese, thus making it possible to avoid overdosage in the animal's diet, and to reduce all phenomena of interference with other dietary components.

To obtain these manganese-rich protein hydrolysates, treatment, for example with lime in certain conditions of pressure and temperature, of connective tissues derived from skin treated in a tannery had already been described in the prior art.

Patent EP 1,909,592 instead proposes obtaining protein hydrolysates enriched in manganese by using, as starting material, a conventional vegetable organic matter, and notably subjecting it to a treatment with lime.

Manganese enrichment of these proteins is then carried out by treating the calcium salts of the protein hydrolysates with manganese sulfates or other manganese salts at high temperatures, dissolved beforehand in sulfuric acid solutions.

It is further necessary to precipitate the residual calcium salts with ammonium bicarbonate, sodium bicarbonate or directly with carbon dioxide and/or other precipitants, for example oxalic acid and phosphoric acid.

It follows from the foregoing that there is still a need for an industrial method that is inexpensive and simple to implement, in other words economically and industrially viable.

The invention therefore has the aim of overcoming the drawbacks of the hydrolysates and methods of the prior art, and the applicant company was able to find, after much research, that this aim could be achieved by proposing a method for preparing alkaline hydrolysates of plant proteins with a high dry matter content on an industrial scale.

This method for preparing alkaline hydrolysates of plant proteins according to the invention comprises the following steps:

1) placing the plant proteins in suspension in water such that they are:

at a concentration between 15 and 30 dry wt %,

at a temperature between 70 and 80° C. and

at a pH between 9.5 and 10.5, by addition of an alkali metal hydroxide chosen from the group consisting of sodium hydroxide and potassium hydroxide, preferably potassium hydroxide, 2) allowing said suspension to incubate for 10 to 15 hours, preferably for 12 hours, at a temperature between 70 and 80° C. and at a pH between 9.5 and 10.5,

3) neutralizing said heated suspension by means of a mineral acid, preferably hydrochloric acid,

4) drying the neutralized suspension to obtain the alkaline hydrolysate.

The first step of the method for obtaining alkaline hydrolysates according to the invention consists in placing the plant proteins in suspension in water such that they are at a concentration between 15 and 30 dry wt %, at a temperature between 70 and 80° C. and at a pH between 9.5 and 10.5 using an alkali metal hydroxide chosen from the group consisting of sodium hydroxide and potassium hydroxide, preferably potassium hydroxide.

On an industrial scale, it is difficult to manipulate plant proteins with such a dry matter content.

This placing in suspension can require from 12 to 20 hours of incorporation of the various ingredients of the mixture.

As will be exemplified hereinafter, the applicant company recommends preheating the alkalinized water and then gradually incorporating therein the plant proteins, until said dry matter content is reached.

The second step of the method for obtaining alkaline hydrolysates according to the invention consists in allowing said suspension to incubate for 10 to 15 hours, preferably for 12 hours, at a temperature between 70 and 80° C., preferably of the order of 75° C., and at a pH between 9.5 and 10.5.

Adjustment of the reaction mixture to a pH of the order of 10 makes it possible to obtain products displaying the best behavior in terms of solubility and emulsifying capacity (“EC” hereinafter).

As for the basicity, it is provided solely by hydroxides of alkali metals, preferably sodium hydroxide (NaOH) or potassium hydroxide (KOH).

Therefore hydroxides of alkaline-earth metals, such as calcium hydroxide, will not be used.

After testing from 55 to 90° C., the reaction temperature was finally selected at a value between 70 and 80° C., preferably of the order of 75° C.

As for the reaction time, it is fixed between 10 and 15 hours.

By proceeding in this manner, the applicant company goes against the prejudices of the prior art, in the sense that:

the actual reaction time is short, of the order of 12 hours, easily industrializable: therefore it is no longer necessary to carry out the reaction for 24 to 48 hours, or even more,

it is not proposed to use hydroxides of calcium or of magnesium. On the contrary, the applicant company found that the use of lime impacted negatively on the quality of the protein hydrolysates obtained.

The third step of the method for obtaining alkaline hydrolysates according to the invention consists in neutralizing the pH by means of a mineral acid, preferably hydrochloric acid.

For example, 1N hydrochloric acid is added to the mixture, with stirring, in order to adjust the pH to 7.

The fourth and last step of the method for obtaining alkaline hydrolysates according to the invention consists in drying the alkaline hydrolysate thus obtained.

For example, the product is dried in a turbine spray dryer (in particular of the NIRO type) with co-current operation. This spray dryer does not have a fines recycling system; it is therefore a single-stage drying. The air entering the spraying tower is heated to 180° C. The feed rate for the tower is adjusted so that the air at tower outlet is at a temperature of the order of 80 to 85° C. These spraying conditions lead to a powder having 6 to 7% of residual moisture.

By employing the method according to the invention, it is possible to obtain alkaline hydrolysates of plant proteins displaying remarkable functional characteristics.

These alkaline hydrolysates of plant proteins are thus characterized by:

a value of water solubility at pH 7.5 between 60 and 100%, preferably between 80 and 98%,

an emulsifying capacity between 60 and 90%, preferably 65 and 85%,

an average length of peptide chain between 10 and 20 amino acids.

The alkaline hydrolysates according to the invention are characterized by their solubility, determined by a test A.

This test A consists in determining the content of water-soluble matter at pH 7.5 by a method of dispersion of a test sample in distilled water and analysis of the supernatant obtained after centrifugation.

A test sample of exactly 2 g and a magnetized bar (for example with the reference No. ECN 442-4510 from the company VWR) are put in a 400-ml beaker. The tare of the whole is found, then 100 g of distilled water at 20° C. ±2° C. is added.

The pH is adjusted to 7.5 with 1N HCl or 1N NaOH and it is made up to exactly 200 g with distilled water.

It is stirred for 30 minutes and then centrifuged for 15 minutes at 3000 g.

After centrifugation, exactly 25 g of supernatant is taken in a previously calibrated crystallizing dish. It is held in a stove at 103° C. to constant weight.

The water solubility is calculated from the following equation:

$$Solubility = \frac{( w 1 - w 2 ) \times 200 \times 100}{25 \times 2}$$

with w1=weight in g of the crystallizing dish after drying

w2=weight in g of the empty crystallizing dish

The alkaline hydrolysates according to the invention therefore have a solubility between 60 and 100%, preferably between 80 and 98%.

The alkaline hydrolysates according to the invention are also characterized by their emulsifying capacity, determined according to a test B.

This test consists in determining the Emulsifying Capacity (“EC” hereinafter) corresponding to the percentage of stable emulsion “cream” formed after centrifugation as a function of a certain concentration of proteins and of oil, using a homogenizer (in particular of the POLYTRON brand and of the type PT 45-80), advantageously equipped with a spindle (in particular of the Easy-clean brand, reference B99582/company Bioblock).

More precisely, this test consists in:

In a tall 2-liter pot (i.e. for example with a height of 23.5 cm and diameter of 11.5 cm), preparing a solution of alkaline protein hydrolysates equivalent to 2.0% of proteins (weight/volume of proteins N×6.25) in 250 ml of demineralized water.

Introducing a magnetized bar (in particular with the reference No. ECN 442-4510 from the company VWR).

Mixing the alkaline protein hydrolysates for 10 minutes on a magnetic stirrer, for example of brand IKA® RCT Classic, at a maximum speed of 1100 rev/min.

Preparing 250 ml of food-grade colza oil.

Removing the magnetized bar.

Immersing the spindle of the POLYTRON (PT 45-80) in the solution, to mid-height of the solution of alkaline protein hydrolysates.

Setting the rotary speed at 5.5 (between 5 and 6), i.e. between 15 200 and 15 450 rpm.

Switching on the stirrer and pour in the 250 ml of colza oil in 1 minute.

Transferring the emulsion to a beaker.

Weighing twice exactly 35 g of the emulsion into two 50-ml graduated centrifuge tubes.

Centrifuging at 1500 g for 5 minutes, at 20° C.

Measuring the volume of the emulsion “cream” after centrifugation.

Measuring the total volume after centrifugation (pellet+water+emulsion cream).

Checking the repeatability between the 2 tubes and between 2 identical tests.

The Emulsifying Capacity will be determined by calculation, using the following equation:

$$EC = \frac{Volume of emulsion cream after centrifugation}{Total volume after centrifugation} \times 100$$

The alkaline hydrolysates according to the invention have a value of EC between 60 and 90%, preferably between 65 and 85%.

The alkaline hydrolysates according to the invention are finally characterized by their average length of peptide chain, determined according to a test C.

This test C consists in calculating the average chain length as follows, where
TN=total nitrogen
TAN=total amino nitrogen
FAA=free amino acids
F=average nitrogen content of the amino acids of the protein in question
ALPC=average length of peptide chains
PAA=number of peptide amino acids
PC=number of peptide chains

TN is then determined according to the method of Dumas A., as cited by BUCKEE, 1994, in Journal of the Institute of BREWING, 100, pp 57-64, a method known by a person skilled in the art, and expressed in mmol/g.

TAN is determined by “Sorensen” formol titration, also known by a person skilled in the art, and expressed in mmol/g.

FAA is determined by HPLC and expressed in mmol/g.

Depending on the proteins in question, the value of F (expressed in mol/mol) is as follows:

pea proteins: 1.29

potato proteins: 1.25

corn proteins: 1.24

The average chain length is equal to the number of peptide amino acids divided by the number of peptide chains, i.e.:

$$ALPC = \frac{PAA}{PC} with \text{:} PAA = ( \frac{TN}{F} ) - FAA and$$

$$PC = TAN - F \times FAA$$

The alkaline hydrolysates according to the invention therefore have an average length of peptide chain between and 20 amino acids, which reflects the partially hydrolyzed character of the proteins.

As will be exemplified hereinafter, the alkaline hydrolysates in accordance with the invention are prepared from plant proteins chosen from the group consisting of pea proteins, potato proteins and corn proteins, preferably pea proteins.

The alkaline protein hydrolysates according to the invention are also characterized by:

their richness (expressed in N×6.25),

their organoleptic quality,

their foaming capacity (hereinafter: “FC”), and

their degree of hydrolysis.

The richness of the hydrolysates, determined by the method known per se by a person skilled in the art, is high, i.e. between 60 and 95%, preferentially between 80 and 85%.

As for the organoleptic quality of the alkaline hydrolysates according to the invention, it was determined notably on alkaline hydrolysates of pea proteins.

The alkaline hydrolysates of pea proteins according to the invention in fact have an entirely satisfactory organoleptic quality, compared with the pea proteins from which they are prepared.

The foaming capacity is, for its part, determined according to test D as follows.

A foam is a dispersion of gas (nitrogen, carbon dioxide, air) bubbles in a liquid or solid continuous phase (containing proteins or their hydrolysates) produced by mechanical agitation.

A solution of 40 ml at 2% (weight/volume of proteins N×6.25) of the protein hydrolysates is prepared with demineralized water in a tall 250-ml beaker (i.e. having for example a height of 12 cm and a diameter of 6 cm).

A magnetized bar is introduced (notably under reference No. ECN 442-4510 from the company VWR). The protein hydrolysates are hydrated for 10 minutes on a magnetic stirrer, for example of the brand IKA® RCT Classic, at a speed of 1100 rev/min.

The magnetized bar is removed.

The total volume before swelling is measured.

The spindle (for example reference G45M) of a homogenizer, such as that of the brand IKA® Werke and of the type ULTRA TURRAX® T50 basic, is immersed in the solution of protein hydrolysates to mid-height of said solution.

The rotary speed is set on position “5” and stirring is carried out for 1 minute.

The whole volume is transferred to a 100-ml graduated cylinder.

The total volume after swelling is measured.

The foaming capacity is then found from the following formula:

$$FC = \frac{Total volume of foam after swelling}{Total volume before swelling} \times 100$$

The loss of stability is expressed by the loss of foam volume after 30 minutes, expressed as a percentage of the initial volume of foam.

The alkaline hydrolysates according to the invention then have a value of FC between 150 and 250%.

Moreover, these alkaline hydrolysates have a degree of hydrolysis (DH) advantageously between 5 and 9. The latter can be determined by calculation, from the following formula:

DH=[(TAN %)×100]/[protein nitrogen] where:

TAN is the total amino nitrogen determined by “Sorensen” formol titration, known by a person skilled in the art, and expressed in mmol/g,

the protein nitrogen is expressed as N×6.25, and measured by the method that is well known by a person skilled in the art.

The alkaline hydrolysates according to the invention can be used advantageously as emulsifiers in the sectors of human or animal food industries, the pharmaceutical industry, the cosmetics industry and chemical industries, in particular in the food sector.

They can also be used in the industries of fermentation, building materials, plastics, textiles, paper and cardboard.

Finally, the present invention relates to compositions, preferably food compositions, containing the alkaline hydrolysates as described above.

These food compositions are preferably emulsions emulsified with said alkaline hydrolysates.

Other features and advantages of the invention will become clear on reading the nonlimiting examples described below.

### EXAMPLES

### Example 1

### Preparation of Pea Protein Hydrolysates

The alkaline hydrolysates of pea proteins according to the invention are prepared as follows:
1) t0: heating of 25 m³ of water at 75° C.,
2) t0+3 hours: addition of 300 1 of 10% potassium hydroxide,
3) t0+4 hours to t0+10 hours: incorporation of 6.300 kg of pea proteins and of 10% potassium hydroxide so as to reach a pH of 10,
4) t0+10 hours to t0+15 hours: incorporation of the 700 kg of pea proteins remaining,
5) t0+15 hours to t0+27 hours: incubation at 75° C. with addition of potassium hydroxide so as to carry out the actual hydrolysis,
6) at t0+27 hours: neutralization with 33% hydrochloric acid (i.e. 242 1 of HCl),
7) at t0+28 hours: drying in a spraying tower.

The product is dried in a turbine spray dryer of the NIRO type with co-current operation. This spray dryer does not have a fines recycling system; it is therefore single-stage drying. The air entering the spraying tower is heated to 230° C.

The feed rate for the tower is controlled so that the air at tower outlet is at a temperature of the order of 90° C., i.e. here of 2800 to 3000 1/h.

These spray-drying conditions lead to production of a powder having a residual moisture of the order of 6%.

The results obtained are shown in table I below:

TABLE I

| | Native protein | Hydrolysate |
|---|---|---|
| | before | according to |
| | hydrolysis | the invention |
| Dry matter (%) | 94.2 | 94 |
| Solubility pH 7.5 (%) | 36.1 | 95.7 |
| EC (%) | 70 | 84 |
| Average length of peptide | 18 | 11 |
| chain | | |
| Degree of hydrolysis | 4.5 | 7.3 |
| Richness (%) | 81.5 | 75.6 |
| FC (% increase in volume | 97 | 90.5 |
| after swelling relative to | | |
| the initial volume) | | |

The hydrolyzed pea proteins according to the invention have an average length of peptide chain of 11.

Hydrolysis of the pea proteins according to the invention makes it possible to significantly increase the solubility and the emulsifying capacity.

Moreover, the foaming power is improved.

The pea protein hydrolysates according to the invention display properties of solubility, and emulsifying and foaming capacities which are better than the properties of the same proteins before hydrolysis.

### Example 2

### Use of the Hydrolysates According to the Invention for the Encapsulation of Oils

Fish oil is encapsulated by spraying an emulsion at 45% of DM and at pH=8.

The oil represents 15% of the dry matter, with the encapsulation carrier and emulsifier varying depending on the formulas.

The emulsion is produced according to the following procedure:

Dissolve the encapsulation carrier and the emulsifier in demineralized water heated to 80° C. (=encapsulating solution)

Adjust the pH to 8 with 1N NaOH

Stir for 20 minutes

Weigh out the oil 5 minutes before the end of this period to avoid oxidation

Make the emulsion using a POLYTRON homogenizer of the type PT 45-80 (equipped with an Easy-clean spindle with the reference B99582 from Bioblock), speed of 9000 rpm: for this, pour the oil into the encapsulating solution (prepared in steps 1 and 2), stirring for 2 minutes.

Transfer the emulsion obtained to a high-pressure homogenizer at 160 bar (30 bar in the 2nd stage and supplementing to 160 bar for the first stage)

Then stir the emulsion, keeping the temperature close to 50° C.

The emulsion thus prepared is sprayed in a single-stage spray dryer (without recycling of the fine particles). The temperature of the incoming air is 185° C.; the flow rate is controlled to give T° outlet=90° C.

The powders obtained are characterized by their water content, activity of water (aw), the degree of encapsulation and by the oxidation state of the oil.

The degree of encapsulation is measured by the difference between total fats and extractable fats (amount of oil fixed by the carrier):

$$degree of encapsulation ( \% ) = ( \frac{\% lipides extractibles}{\% lipides totaux} ) \times 100$$

The lipids are determined by Soxhlet extraction with hexane:

on the product as it is for the extractable lipids,

on the product after hydrolysis for the total lipids.

The oxidation stability is determined according to standard NF ISO 6886.

The induction time corresponds to the time taken to oxidize a fat in given conditions (temperature, air flow rate, weight of product).

Spraying of emulsions at 45% of DM and pH =8 containing:

15% of fish oil,

1.2 or 1.8% of emulsifier: native pea protein/pea protein hydrolysate from example 1,

respectively 83.5% or 83.2% of carrier: maltodextrin of DE 12 (GLUCIDEX® 12 marketed by the company ROQUETTE FRERES),

is then carried out.

The sprayed powders have an activity of water of 0.1.

Their water content is 5% for the tests with 1.2% of emulsifier and 4% for the tests with 1.8% of emulsifier.

Table II: degree of encapsulation (%) and induction time (h) of the emulsions sprayed with maltodextrin of DE 12

TABLE II

| | Degree of | Induction |
|---|---|---|
| Nature and content of | encapsulation | time |
| emulsifier | (%) | (h) |
| 1.2% Native pea proteins | 78.3 | 6.0 |
| 1.2% Pea protein | 89 | 9 |
| hydrolysates according | | |
| to the invention | | |
| 1.8% Native pea proteins | 83.2 | 6.7 |
| 1.8% Pea protein | 92 | 13 |
| hydrolysates according | | |
| to the invention | | |

With the maltodextrin carrier of DE 12, using the pea protein hydrolysate according to the invention at a level of 1.2% makes it possible to encapsulate up to 89% of oil versus 78.3% with the native pea protein.

The oil then has an induction time of 9 h versus 6 h.

For both concentrations of emulsifier, the degree of encapsulation is greater when using the pea protein hydrolysate according to the invention rather than the native pea protein.

Likewise, the induction time is greater when using the pea protein hydrolysate according to the invention rather than the native pea protein.

Therefore the oil oxidizes less quickly.

1. A method for preparing alkaline hydrolysates of plant proteins, characterized in that it comprises the following steps:
1) placing the plant proteins in suspension in water such that they are
at a concentration between 15 and 30 dry wt %,
at a temperature between 70 and 80° C. and
at a pH between 9.5 and 10.5, by addition of an alkali metal hydroxide chosen from the group consisting of sodium hydroxide and potassium hydroxide, preferably potassium hydroxide,
2) allowing said suspension to incubate for 10 to 15 hours, preferably for 12 hours, at a temperature between 70 and 80° C. and at a pH between 9.5 and 10.5,
3) neutralizing said heated suspension by means of a mineral acid, preferably hydrochloric acid,
4) drying the neutralized suspension to obtain the alkaline hydrolysate.

2. The alkaline hydrolysates obtained by implementing the method of claim 1, and having a water solubility value between 60 and 100% at pH 7.5, an emulsifying capacity between 60 and 90%, and an average length of peptide chain between 10 and 20 amino acids.

3. A food composition containing alkaline hydrolysates obtained by implementing the method of claim 1.

4. The food composition as claimed in claim 3, characterized in that it is an emulsion emulsified by said alkaline hydrolysates.
